(19) United States
(12) Patent Application Publication
(10) Pub. No.: US 2015/0318549 A1
(43) Pub. Date: Nov. 5, 2015

(54) ELECTRICITY STORAGE DEVICE, ELECTRODE USED THEREIN, AND POROUS SHEET

(71) Applicant: NITTO DENKO CORPORATION, Ibaraki-shi, Osaka (JP)

(72) Inventors: Yutaka KISHII, Ibaraki-shi (JP); Masao ABE, Ibaraki-shi (JP); Akira OTANI, Ibaraki-shi (JP); Yoshihiro UETANI, Ibaraki-shi (JP)

(73) Assignee: NITTO DENKO CORPORATION, Ibaraki-shi, Osaka (JP)

(21) Appl. No.: 14/646,760

(22) PCT Filed: Nov. 26, 2013
(86) PCT No.: PCT/JP2013/081694

§ 371 Date: May 22, 2015

(30) Foreign Application Priority Data
Nov. 30, 2012 (JP) 2012-262203

(51) Int. Cl. H01M 4/60; H01M 10/0525

(52) U.S. Cl. CPC H01M 4/602; H01M 10/0525

(57) ABSTRACT

For achievement of a novel electricity storage device excellent in charge and discharge velocity and in capacity density, and an electrode and a porous sheet for use in the same, an electricity storage device including an electrolyte layer, a positive electrode, and a negative electrode is provided, wherein the electrolyte layer is interposed between the electrodes, and wherein at least one of the electrodes is a porous film made from a solution having an electrically conductive polymer in a reduced state.

### TECHNICAL FIELD

The present invention relates to an electricity storage device, and an electrode and a porous sheet for use in the same. More particularly, the present invention relates to a novel electricity storage device having both high-speed charge and discharge characteristics of an electric double layer capacitor and excellent capacity density characteristics of a lithium-ion secondary battery, and an electrode and a porous sheet for use in the same.

### BACKGROUND ART

With recent improvement and advancement of electronics technology for mobile PCs, mobile phones and personal digital assistants (PDAs), secondary batteries and the like, which can be repeatedly charged and discharged, are widely used as electricity storage devices for these electronic apparatuses. Increases in capacity of an electrode material and high-speed charge and discharge characteristics are desirable for electrochemical electricity storage devices such as these secondary batteries.

An electrode for such an electricity storage device contains an active material which is capable of ion insertion/desertion. The ion insertion/desertion of the aforementioned active material is also referred to as doping/dedoping, and the doping/dedoping amount per unit molecular structure is referred to as dope ratio (or doping ratio). A material having a higher doping ratio can provide a higher capacity battery.

From an electrochemical viewpoint, the capacity of the battery can be increased by using an electrode material having a greater ion insertion/desertion amount. In lithium secondary batteries which are attractive electricity storage devices, more specifically, a graphite-based negative electrode capable of lithium ion insertion/desertion is used in which about one lithium ion is inserted and deserted with respect to six carbon atoms to provide a higher capacity.

Of these lithium secondary batteries, a lithium secondary battery which has a higher energy density and, therefore, is widely used as the electricity storage device for the aforesaid electronic apparatuses includes a positive electrode prepared by using a lithium-containing transition metal oxide such as lithium manganese oxide or lithium cobalt oxide, and a negative electrode prepared by using a carbon material capable of lithium ion insertion/desertion, the positive electrode and the negative electrode being disposed in opposed relation in an electrolyte solution.

However, the aforementioned lithium secondary battery, which generates electric energy through an electrochemical reaction, disadvantageously has a lower power density because of its lower electrochemical reaction rate. Further, the lithium secondary battery has a higher internal resistance, so that rapid discharge and rapid charge of the secondary battery are difficult. In addition, the secondary battery generally has a shorter service life, i.e., a poorer cycle characteristic, because the electrodes and the electrolyte solution are degraded due to the electrochemical reaction associated with the charge and the discharge.

There is also known a lithium secondary battery in which an electrically conductive polymer such as a polyaniline containing a dopant is used as a positive electrode active material to cope with the aforesaid problem (see PTL1).

In general, however, the secondary battery employing the electrically conductive polymer as the positive electrode active material is of an anion migration type in which the electrically conductive polymer is doped with an anion in a charge period and dedoped with the anion in a discharge period. Where a carbon material or the like capable of lithium ion insertion/desertion is used as a negative electrode active material, it is impossible to provide a rocking chair-type secondary battery of a cation migration type in which the cation migrates between the electrodes in the charge/discharge. That is, the rocking chair-type secondary battery is advantageous in that only a smaller amount of the electrolyte solution is required, but the secondary battery employing the electrically conductive polymer as the positive electrode active material cannot enjoy this advantage. Therefore, it is impossible to contribute to the size reduction of the electricity storage device.

To cope with this problem, a secondary battery of a cation migration type is proposed, which is substantially free from change in the ion concentration of the electrolyte solution without the need for a greater amount of the electrolyte solution, and aims at improving the capacity density per unit volume or per unit weight and energy density. This secondary battery includes a positive electrode prepared by using an electrically conductive polymer containing a polymer anion such as polyvinyl sulfonate as a dopant, and a negative electrode of metal lithium (see PTL2).

On the other hand, a method is proposed which uses the property that polyaniline is soluble in a solvent to produce a film by using a polyaniline solution and to thereafter add a poor solvent while the volatilization of the solvent is insufficient, thereby forming a film having high porosity (porous film), so that this film is used as an electrode. This method easily provides a porous electrode which an electrolyte solution easily enters (see PTL3).

### RELATED ART DOCUMENT

### Patent Documents

PATENT DOCUMENT 1: JP-A-HEI3(1991)-129679

PATENT DOCUMENT 2: JP-A-HEI1(1989)-132052

PATENT DOCUMENT 3: JP-A-HEI2(1990)-220373

### SUMMARY OF INVENTION

The present invention has been made to solve the aforementioned problems. In particular, the present invention provides a novel electricity storage device which achieves the increase in doping ratio of an electrically conductive polymer having electrical conductivity varied by ion insertion/desertion and which has a high capacity density and a high energy density, and further provides an electrode and a porous sheet for use in the aforementioned electricity storage device.

A first aspect of the present invention is an electricity storage device comprising an electrolyte layer, and a positive electrode and a negative electrode provided, with the electrolyte layer interposed therebetween, wherein at least one of the electrodes is a porous film made from a solution having an electrically conductive polymer (A) in a reduced state.

Also, a second aspect is an electrode for an electricity storage device, the electrode being a porous film made from a solution having an electrically conductive polymer (A) in a reduced state.

Further, a third aspect is a porous sheet for an electricity storage device electrode, the porous film being made from a solution having an electrically conductive polymer (A) in a reduced state.

The present inventors have made studies to obtain an electricity storage device which includes an electrode prepared by employing an electrically conductive polymer and which has a high capacity density and a high energy density. In the course of the studies, the present inventors have directed attention toward making porous an electrically conductive polymeric material having electrical conductivity varied by ion insertion/desertion, and have made further studies about this. As a result, the present inventors have found that an electrically conductive polymer is made porous in the process of dissolving the electrically conductive polymer in a reduced state in a solvent and substituting the solvent with a poor solvent and the like. Further, the present inventors have found that electricity storage device characteristics using this porous property are significantly improved.

The expression “made from a . . . solution” as used in the present invention means “being produced from a . . . solution (forming material)”.

In this manner, the electricity storage device comprises an electrolyte layer, and a positive electrode and a negative electrode provided, with the electrolyte layer interposed therebetween, wherein at least one of the electrodes is a porous film made from a solution having an electrically conductive polymer (A) in a reduced state. This provides a high-performance electricity storage device excellent in capacity density per active material weight. The aforementioned active material means an electrically conductive polymer having an oxidation/reduction function.

Also, when the solution having the electrically conductive polymer (A) in the reduced state further contains a polycarboxylic acid (B), the resultant electricity storage device provides a more excellent capacity density because of the dopant function of the polycarboxylic acid (B) or is capable of maintaining characteristics such as a good capacity density even when the amount of electrolyte solution is reduced.

Further, when the solution having the electrically conductive polymer (A) in the reduced state further contains a conductive agent (C), the resultant electricity storage device provides a more excellent capacity density or is capable of maintaining characteristics such as a good capacity density even when the amount of electrolyte solution is reduced.

Further, the porous sheet for an electricity storage device electrode comprises a composite including at least the electrically conductive polymer (A) and the polycarboxylic acid (B), wherein the polycarboxylic acid (B) is fixed in the electrode. Therefore, the electricity storage device employing this porous sheet is excellent in charge and discharge characteristics and in capacity density.

### BRIEF DESCRIPTION OF DRAWINGS

FIG. 1 is a sectional view schematically showing a structure of an electricity storage device.

FIG. 2 is graph showing plots of a capacity density (mAh/g) along a vertical axis versus an electrolyte solution weight/polyaniline weight (mg/mg) along a horizontal axis for electricity storage devices in inventive and comparative examples, the capacity density being converted per polyaniline weight.

FIG. 3 is graph showing plots of a capacity density (mAh/g) along a vertical axis versus an electrolyte solution weight/polyaniline weight (mg/mg) along a horizontal axis for electricity storage devices in inventive and comparative examples, the capacity density being converted per total weight of the polyaniline and the electrolyte solution.

### DESCRIPTION OF EMBODIMENTS

An embodiment of the present invention will hereinafter be described in detail by way of example but not by way of limitation.

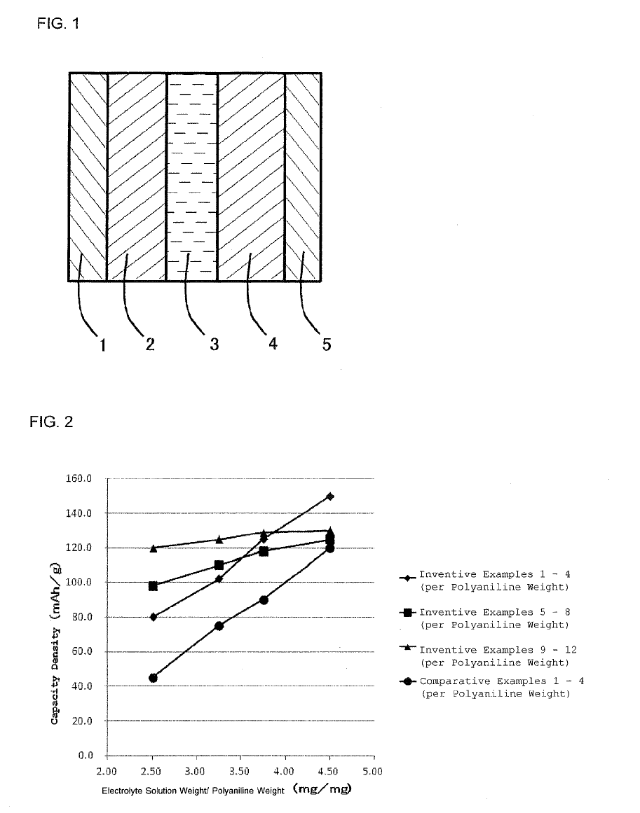

As shown in FIG. 1, an electricity storage device according to the present invention is an electricity storage device having an electrolyte layer 3, and a positive electrode 2 and a negative electrode 4 disposed in opposed relation, with the electrolyte layer 3 interposed therebetween. At least one of the electrodes is a porous film made from a solution having an electrically conductive polymer (A) in a reduced state.

The most striking characteristic of the present invention is the porous film made from an electrically conductive polymer solution in a reduced state, as stated above. The materials which form the porous film and the like will be described step by step.

<Electrically Conductive Polymer (A)>

The “electrically conductive polymer” will be described. The electrically conductive polymer generally refers to a polymer having a structure which develops electrical conductivity. In general, the electrically conductive polymer refers to a composite of a low-molecular ion known as a dopant and a polymer. The dopant is inserted and deserted depending on the oxidized and reduced states of the electrically conductive polymer. Therefore, the electrically conductive polymer according to present invention generically refers to a polymer having a structure which develops electrical conductivity, irrespective of whether the polymer is composited with a dopant or not. For example, even when polyaniline in a reduced state is not composited with a dopant and has low electrical conductivity, this polymer is referred to as an electrically conductive polymer.

The aforementioned electrically conductive polymer can be said to be a polymer having electrical conductivity varied by ion insertion/desertion. Examples of the electrically conductive polymer include polyacetylene, polypyrrole, polyaniline, polythiophene, polyfuran, polyselenophene, polyisothianaphthene, polyphenylene sulfide, polyphenylene oxide, polyazulene, poly(3,4-ethylenedioxythiophene), and various derivatives thereof. In particular, polyaniline, polyaniline derivatives, polypyrrole and polypyrrole derivatives are preferably used because of their higher electrochemical capacity, and polyaniline and polyaniline derivatives are further preferably used.

As stated earlier, the ion insertion/desertion of the aforementioned electrically conductive polymer (A) is also referred to as what is called doping/dedoping, and the doping/dedoping amount per unit molecular structure is referred to as a doping ratio. A material having a higher doping ratio can provide a higher capacity battery.

For example, it is said that the doping ratio of the electrically conductive polymer is as follows: 0.5 for polyaniline, and 0.25 for polypyrrole. A higher doping ratio can provide a higher capacity battery. For example, the electrical conductivity of electrically conductive polyaniline is on the order of 10⁰ to 10³ S/cm in a doped state, and is 10⁻¹⁵ to 10⁻² S/cm in a dedoped state.

In the present invention, the aforementioned electrically conductive polymer is placed into a reduced state to form a solution, and a porous film is made from the solution. It is inferred that, when the electrically conductive polymer is in an oxidized state, a hydrogen bond provides close intermolecular bonding, which in turn causes the decrease in solubility in a gel state. In this manner, the electrically conductive polymer in the form of a solution is improved in doping ratio because a portion thereof which cannot conventionally function as an active material due to the influence of gelation and the like can be used as an active material.

An example of a method of placing the aforementioned electrically conductive polymer into a reduced state in the early stage includes a reduced-dedoped state. For the reduced-dedoped state, there is a method which directly places the electrically conductive polymer into the reduced-dedoped state. In general, however, a method in which the electrically conductive polymer is reduced after being placed into the dedoped state is employed.

The aforementioned method in which the electrically conductive polymer is reduced after being placed into the dedoped state will be described in detail. First, the dedoped state is obtained by neutralizing (performing an alkali treatment on) a dopant of the electrically conductive polymer. For example, the electrically conductive polymer in the dedoped state is obtained by stirring in a solution which neutralizes the dopant of the aforementioned electrically conductive polymer and thereafter washing and filtering. A specific example of the method of dedoping the electrically conductive polymer containing tetrafluoroboric acid as a dopant includes stirring in a sodium hydroxide aqueous solution to accomplish neutralization.

Next, the reduced-dedoped state is obtained by reducing the polymer in the dedoped state. For example, the electrically conductive polymer in the reduced-dedoped state is obtained by stirring in a solution which reduces the electrically conductive polymer in the dedoped state and thereafter washing and filtering. A specific example of the method of reducing the electrically conductive polymer in the dedoped state includes stirring the electrically conductive polymer in the dedoped state in a phenylhydrazine methanol aqueous solution (reduction treatment).

As described above, the electrically conductive polymer in the reduced state is formed into a solution, and a porous film is made from this solution. Examples of a solvent for dissolving the electrically conductive polymer in the reduced state include organic solvents such as acetone, methanol, ethanol, isopropyl alcohol, xylene, ethyl acetate, toluene and N-methylpyrrolidone, or water, which may be used either alone or in combination.

A preferred combination of the aforementioned electrically conductive polymer and the aforementioned solvent includes a combination of an electrically conductive polymer and a solvent having a high affinity. Examples of such a combination include combinations of sulfonated electrically conductive polymers and water, and combinations of electrically conductive polymers of alkyl substitution products and organic solvents.

Among the aforementioned electrically conductive polymers of alkyl substitution products, polyaniline derivatives are preferably used because of their high solubility in organic solvents. Examples of the polyaniline derivatives include polyaniline derivatives prepared by substituting aniline at positions other than the 4-position thereof with at least one substituent selected from the group consisting of alkyl groups, alkenyl groups, alkoxy groups, aryl groups, aryloxy groups, alkylaryl groups, arylalkyl groups and alkoxyalkyl groups. In particular, o-substituted anilines such as o-methylaniline, o-ethylaniline, o-phenylaniline, o-methoxyaniline and o-ethoxyaniline, and m-substituted anilines such as m-methylaniline, m-ethylaniline, m-methoxyaniline, m-ethoxyaniline and m-phenylaniline are preferably used. These may be used either alone or in combination.

Also, the electrically conductive polymer, when not substituted, is dissolved in polar solvents such as N-methylpyrrolidone. For this reason, combinations of the electrically conductive polymer and such polar solvents are preferably used.

In the present invention, the electrically conductive polymer in the reduced state is dissolved in the aforementioned solvent, and a porous film is made from the resulting solution. In the present invention, it is preferable that a solution having the aforementioned electrically conductive polymer (A) in the reduced state further contains a polycarboxylic acid (B) and a conductive agent (C), which in turn provide a higher-performance electrode for the electricity storage device. Also, a binder such as vinylidene fluoride may be added to the solution.

<Polycarboxylic Acid (B)>

Examples of the aforementioned polycarboxylic acid (B) include polymers, carboxylic acid substituted compounds each having a relatively great molecular weight, and carboxylic acid substituted compounds having a lower solubility in an electrolyte solution. More specifically, a compound having a carboxyl group in its molecule is preferably used. In particular, a polymeric polycarboxylic acid (B), which can function also as a binder, is more preferably used.

Examples of the polymeric polycarboxylic acid (B) include polyacrylic acid, polymethacrylic acid, polyvinylbenzoic acid, polyallylbenzoic acid, polymethallylbenzoic acid, polymaleic acid, polyfumaric acid, polyglutamic acid and polyasparaginic acid, among which polyacrylic acid and polymethacrylic acid are particularly preferred. These polycarboxylic acids may be used either alone or in combination.

When the aforementioned polycarboxylic acid is used, this polymer functions as a binder and also as a dopant to provide a rocking chair-type mechanism. This seems to be involved in improvements in the characteristic properties of the electricity storage device according to the present invention.

An example of the aforementioned polycarboxylic acid (B) preferably used herein includes a polycarboxylic acid of lithium-exchanged type prepared by substituting lithium for at least part of carboxyl groups in the polymer. Such lithium substitution is preferably performed on not less than 40% of the carboxyl groups in the polymer, and more preferably 100% thereof.

The aforementioned polycarboxylic acid (B) is generally used in an amount of 1 to 100 parts by weight, preferably 2 to 70 parts by weight, most preferably 5 to 40 parts by weight, based on 100 parts by weight of the electrically conductive polymer (A). This is because it tends to be impossible to provide an electricity storage device excellent in energy density if the amount of the polycarboxylic acid (B) is either excessively small or excessively great with respect to the aforementioned electrically conductive polymer (A).

<Conductive Agent (C)>

Examples of the aforementioned conductive agent (C) used herein include graphites (graphitic carbon materials) such as natural graphite (flaky graphite and the like) and artificial graphite, carbon blacks such as acetylene black, Ketjen black, channel black, furnace black, lampblack and thermal black, carbon materials such as carbon fibers, and powders of precious metals such as gold, platinum and silver. In particular, carbon blacks are preferably used because of their good compatibility with the electrically conductive polymer.

The aforementioned conductive agent (C) is preferably 1 to 30 parts by weight, more preferably 4 to 20 parts by weight, especially preferably 8 to 18 parts by weight, based on 100 parts by weight of the electrically conductive polymer (A). If the amount of the conductive agent (C) to be mixed is in this range, the active material is prepared without anomalies in its shape and characteristics to effectively improve rate characteristics.

<Production of Electrode>

The electrode in the form of a porous film is produced, for example, in the following manner. First, the electrically conductive polymer in the reduced state is dissolved in a solvent (good solvent) having a high solubility, so that a polymer solution is prepared. A polycarboxylic acid aqueous solution dissolved in water, the conductive agent, the binder and the like are further added, as required, to the polymer solution, and sufficiently dispersed. The resulting polymer solution is cast on an appropriate base material, and part of the solvent is evaporated at an appropriate temperature. After the viscosity of the polymer solution is increased, the polymer solution is exposed to an appropriate poor solvent to thereby form a porous film by what is called solvent substitution. The polymer formed into the porous film is further dried so that the remaining solvent is removed, whereby an intended porous film is obtained. The aforementioned obtained porous film may be used as an electrode for the electricity storage device according to the present invention.

<Electrode>

The electrode for the electricity storage device according to the present invention is formed from the porous film made from a solution having the electrically conductive polymer (A) in the reduced state, as described above. In general, the thickness of the electrode is preferably 1 to 1000 μm, and more preferably 10 to 700 μm.

The thickness of the aforementioned electrode is obtained by measuring the electrode by means of a dial gage (available from Ozaki Mfg. Co., Ltd.) which is a flat plate including a distal end portion having a diameter of 5 mm, and then averaging the values measured at ten points on a surface of the electrode. When the electrode (porous film) is provided on a current collector and composited with the current collector, the thickness of the electrode is obtained by measuring the thickness of the composite in the aforementioned manner, taking the average of the measurement values, and then subtracting the thickness of the current collector.

The electrode has a porosity (%) which is preferably 40% to 95%, and more preferably 65% to 90%.

The porosity (%) of the electrode according to the present invention is calculated by {(apparent volume of electrode−absolute volume of electrode)/apparent volume of electrode}×100. The absolute volume of the electrode as used in the present invention refers to the “volume of electrode constituent materials”. Specifically, the absolute volume of the electrode is determined by calculating the mean density of all electrode constituent materials with the use of the weight proportion of the constituent materials of the electrode and the value of the true density of each constituent material and then dividing the sum total of the weights for the electrode constituent materials by the mean density.

The true density (absolute specific gravity) of each of the aforementioned constituent materials is as follows: 1.2 for polyaniline, 1.2 for polyacrylic acid, and 2.0 for DENKA BLACK (acetylene black).

The apparent volume of the aforementioned electrode refers to “electrode area×electrode thickness of electrode”, and specifically is the sum total of the volume of the substance of the electrode, the volume of voids in the electrode and the volume of the space of uneven portions on the surface of the electrode.

In the electrode which is a porous film formed by adding the polycarboxylic acid (B) to an electrically conductive polymer solution, the polycarboxylic acid (B), which is present as a mixture with the component A, is thus fixed in the electrode. The polycarboxylic acid (B) fixedly disposed near the component A in this manner is used also for charge compensation during the oxidation/reduction of the electrically conductive polymer (A).

Thus, the electricity storage device according to the present invention has a rocking chair-type ion migration mechanism to require small quantities of anions in the electrolyte solution serving as a dopant. This results in the electricity storage device capable of giving rise to good characteristics even when the amount of usage of the electrolyte solution is small.

<Electrolyte Layer>

The electrolyte layer in the electricity storage device according to the present invention is formed from an electrolyte. For example, a sheet including a separator impregnated with an electrolyte solution or a sheet made of a solid electrolyte is preferably used. The sheet made of the solid electrolyte per se functions as a separator.

The aforementioned electrolyte includes a solute and, as required, a solvent and additives. Preferred examples of the solute include compounds prepared by combining together at least one cation selected from the group consisting of a proton, an alkali metal ion such as a lithium ion, a quaternary ammonium ion and a quaternary phosphonium ion, and at least one anion serving as its proper counter ion and selected from the group consisting of a sulfonate ion, a perchlorate ion, a tetrafluoroborate ion, a hexafluorophosphate ion, a hexafluoroarsenate ion, a bis(trifluoromethanesulfonyl)imide ion, a bis(pentafluoroethanesulfonyl)imide ion, a halide ion, a phosphate ion, a sulfate ion and a nitrate ion. Accordingly, specific examples of the electrolyte include LiCF₃SO₃, LiClO₄, LiBF₄, LiPF₆, LiAsF₆, LiN(SO₂CF₃)₂, LiN(SO₂C₂F₅)₂ and LiCl.

Examples of the solvent used as required include nonaqueous solvents, i.e., organic solvents, such as carbonates, nitriles, amides and ethers, at least one of which is used. Specific examples of the organic solvents include ethylene carbonate, propylene carbonate, butylene carbonates, dimethyl carbonate, diethyl carbonate, ethyl methyl carbonate, acetonitrile, propionitrile, N,N′-dimethylacetamide, N-methyl-2-pyrrolidone, dimethoxyethane, diethoxyethane and γ-butyrolactone, which may be used either alone or in combination. A solution prepared by dissolving the aforementioned solute in the solvent may be referred to as an “electrolyte solution” in some cases.

In the present invention, a separator may be used in addition to the aforementioned electrode and the electrolyte, and can be used in a variety of forms. The aforementioned separator is only required to be capable of preventing an electrical short circuit between the positive electrode and the negative electrode disposed in opposed relation with the separator interposed therebetween. A preferred example of the separator used herein includes an insulative porous sheet which is electrochemically stable and which has a higher ionic permeability and a certain mechanical strength. Therefore, exemplary materials for the separator include paper, nonwoven fabric, porous sheets having porosity and made of a resin such as polypropylene, polyethylene or polyimide, which may be used either alone or in combination. Also, when the electrolyte layer is a sheet made of a solid electrolyte as described above, the electrolyte layer per se functions as a separator. It is hence unnecessary to prepare another separator separately.

<Negative Electrode>

Preferred examples of a negative electrode active material according to the present invention include metal lithium, carbon materials and transition metal oxides capable of insertion and desertion of ions in oxidation and reduction, silicon and tin. The term “use” as used in the present invention is to be interpreted as including meaning that the forming material is used in combination with a second forming material in addition to meaning that only the forming material is used. The proportion of the second forming material to be used is generally less than 50% by weight of the forming material.

The reason why the electricity storage device according to the present invention has such a high capacity lies in the use of the electrically conductive polymer solution in the reduced state. The reason why the electrically conductive polymer solution in the reduced state is higher in capacity than the electrically conductive polymer in the oxidized state is not clear, but it is inferred that the dedoping treatment and the reduction treatment improve the solubility of the electrically conductive polymer to result in the increase in homogeneity of the solution. It is also inferred that pores suitable for the battery are formed in the subsequent steps of film production and poor solvent substitution to provide a still higher capacity.

When the polycarboxylic acid is added, the polycarboxylic acid is disposed in the porous film as a mixture with the electrically conductive polymer, and is thus fixed in the porous film (electrode). The polycarboxylic acid fixedly disposed near the electrically conductive polymer in this manner is used for charge compensation during the oxidation/reduction of the electrically conductive polymer.

Also, the ionic environment of the polycarboxylic acid facilitates the migration of ions inserted/deserted from the electrically conductive polymer. For this and other reasons, the doping ratio of the electrically conductive polymer is improved. Further, the provision of the rocking chair-type ion migration mechanism requires small quantities of anions in the electrolyte solution serving as a dopant. As a result, the electricity storage device capable of giving rise to good characteristics even when the amount of usage of the electrolyte solution is small is provided.

In this manner, the electrode of the electricity storage device not only has a capacity density higher than that of the conventional electric double layer capacitor, but also is excellent in charge and discharge characteristics, like the electric double layer capacitor. From this, it can be said that the electricity storage device according to the present invention is a capacitor-type secondary battery.

### EXAMPLES

Inventive examples will hereinafter be described in conjunction with comparative examples. However, the present invention is not limited to these examples.

The following components were prepared before the production of electricity storage devices according to the inventive examples and the comparative examples.

<Preparation of Electrically Conductive Polyaniline Powder>

Powder of an electrically conductive polyaniline (electrically conductive polymer) containing tetrafluoroboric acid as a dopant was prepared in the following manner. That is, 84.0 g (0.402 mol) of a tetrafluoroboric acid aqueous solution (special grade reagent available from Wako Pure Chemical Industries, Ltd.) having a concentration of 42 wt % was added to 138 g of ion-exchanged water contained in a 300-mL volume glass beaker. Then, 10.0 g (0.107 mol) of aniline was added to the resulting solution, while the solution was stirred by a magnetic stirrer. Immediately after the addition of aniline to the tetrafluoroboric acid aqueous solution, aniline was dispersed in an oily droplet form in the tetrafluoroboric acid aqueous solution, and then dissolved in water in several minutes to provide a homogeneous transparent aniline aqueous solution. The aniline aqueous solution thus provided was cooled to −4° C. or lower with the use of a refrigerant incubator.

Then, 11.63 g (0.134 mol) of a powdery manganese dioxide oxidizing agent (Grade-1 reagent available from Wako Pure Chemical Industries, Ltd.) was added little by little to the aniline aqueous solution, while the mixture in the beaker was kept at a temperature of not higher than −1° C. Immediately after the oxidizing agent was thus added to the aniline aqueous solution, the color of the aniline aqueous solution turned dark green. Thereafter, the solution was continuously stirred, whereby generation of a dark green solid began.

After the oxidizing agent was added in 80 minutes in this manner, the resulting reaction mixture containing the reaction product thus generated was cooled, and further stirred for 100 minutes. Thereafter, the resulting solid was suction-filtered through No. 2 filter paper (available from ADVANTEC Corporation) with the use of a Buchner funnel and a suction bottle to provide powder. The powder was washed in an about 2 mol/L tetrafluoroboric acid aqueous solution with stirring by means of the magnetic stirrer, then washed in acetone several times with stirring, and suction-filtered. The resulting powder was dried in vacuum at a room temperature (25° C.) for 10 hours. Thus, 12.5 g of an electrically conductive polyaniline containing tetrafluoroboric acid as a dopant (referred to simply as an “electrically conductive polyaniline” hereinafter) was provided, which was bright green powder.

(Electrical Conductivity of Electrically Conductive Polyaniline Powder)

After 130 mg of the electrically conductive polyaniline powder was milled in an agate mortar, the resulting powder was compacted into an electrically conductive polyaniline disk having a diameter of 13 mm and a thickness of 720 μm in vacuum at a pressure of 75 MPa for 10 minutes by means of a KBr tablet forming machine for infrared spectrum measurement. The disk had an electrical conductivity of 19.5 S/cm measured by the Van der Pauw method using the four-point probe.

(Preparation of Dedoped Polyaniline Powder)

The electrically conductive polyaniline powder provided in the doped state in the aforementioned manner was put in a 2 mol/L sodium hydroxide aqueous solution, and stirred in a 3-L separable flask for 30 minutes. Thus, the electrically conductive polyaniline powder was dedoped with the tetrafluoroboric acid dopant through a neutralization reaction. The dedoped polyaniline was washed with water until the filtrate became neutral. Then, the dedoped polyaniline was washed in acetone with stirring, and suction-filtered through No. 2 filter paper with the use of a Buchner funnel and a suction bottle. Thus, dedoped polyaniline powder was provided on the No. 2 filter paper. The resulting powder was dried in vacuum at a room temperature for 10 hours, whereby brown dedoped polyaniline powder was provided.

### Inventive Example 1

### Production of Positive Electrode

(Preparation of Polyaniline Powder in Reduced State)

Next, the polyaniline powder in the dedoped state was put in a phenylhydrazine methanol aqueous solution, and reduced for 30 minutes with stirring. Due to the reduction, the color of the polyaniline powder turned from brown to gray. After the reaction, the resulting polyaniline powder was washed with methanol and then with acetone, filtered, and dried in vacuum at a room temperature. Thus, reduced-dedoped polyaniline was provided.

The aforementioned powder had a median diameter of 13 μm as measured by a light-scattering method using acetone as a solvent.

(Electrical Conductivity of Reduced-Dedoped Polyaniline Powder)

After 130 mg of the reduced-dedoped polyaniline powder was milled in an agate mortar, the resulting powder was compacted into a reduced-dedoped polyaniline disk having a thickness of 720 μm in vacuum at a pressure of 75 MPa for 10 minutes by means of a KBr tablet forming machine for infrared spectrum measurement. The disk had an electrical conductivity of 5.8×10⁻³ S/cm measured by the Van der Pauw method using the four-point probe. This means that the polyaniline compound was an active material compound having an electrical conductivity variable due to ion insertion/desertion.

(Production of Polyaniline Porous Film in Reduced State)

At a room temperature, 5 g of the reduced-dedoped polyaniline powder was stirred to dissolve in 95 g of N-methyl-2-pyrrolidone (referred to hereinafter as “NMP”). The resulting solution was suction-filtered, so that insoluble matter was removed and the solution was defoamed.

This solution was applied onto a glass plate to a coating thickness of 360 μm by means of a Baker-type film applicator. After the coating, the process of drying by heating was performed at 120° C. for 10 minutes in a hot air circulation-type dryer, so that a film-shaped product containing NMP was formed on the glass plate.

Thereafter, the film-shaped product together with the glass plate was immersed in an ice bath for 1 hour, so that the NMP present inside the film was substituted with water. Thereafter, the solvent was substituted with acetone and hexane in the order named. Then, the film-shaped product together with the glass plate was inserted between sheets of filter paper, and was allowed to air-dry in that state.

A porous film thus obtained had a thickness of 195 μm and a porosity of 89%.

[Preparation of Negative Electrode Material]

Metal lithium (rolled metal lithium available from Honjo Metal Co., Ltd.) having a thickness of 50 μm was prepared.

[Preparation of Electrolyte Solution]

An ethylene carbonate/dimethyl carbonate solution containing lithium tetrafluoroborate (LiBF₄) at a concentration of 1 mol/dm³ (available from Kishida Chemical Co., Ltd.) was prepared.

[Preparation of Separator]

A nonwoven fabric (TF40-50 (having a porosity of 55%) available from Hohsen Corporation) was prepared.

<Production of Electricity Storage Device>

Next, the assembly of a cell that is an electricity storage device (lithium secondary battery) through the use of the porous film provided in the aforementioned manner and the aforementioned other prepared materials will be described.

Prior to the assembling to the cell, a produced positive electrode sheet and the prepared separator were dried in vacuum at 100° C. for 5 hours by means of a vacuum dryer. Then, the assembly to be described below was performed in a glove box having a dew point of −100° C. in an ultrapure argon gas atmosphere. First, the porous film provided in the aforementioned manner was punched out in the form of a disk by means of a punching tool equipped with a punching blade having a diameter of 15.95 mm to provide a positive electrode. The positive electrode and a prepared negative electrode were disposed in properly opposed relation in a stainless steel HS cell (available from Hohsen Corporation) for a nonaqueous electrolyte solution secondary battery experiment, and the separator was positioned to prevent an electrical short circuit between the positive electrode and the negative electrode. The aforementioned positive electrode sheet and the separator were dried in vacuum at 100° C. for 5 hours by means of a vacuum dryer before being assembled to the HS cell. Then, the prepared electrolyte solution was fed into the cell so that the weight thereof was 4.5 times the weight (mg) of the electrically conductive polyaniline forming the positive electrode. Thus, the cell which was the electricity storage device was completed. That is, the fed electrolyte solution weight (mg) satisfies the equation: electrolyte solution weight (mg)/polyaniline weight (mg)=4.5 (mg/mg).

### Inventive Examples 2 to 4

A cell was produced in substantially the same manner as in Inventive Example 1 except that the electrolyte solution weight (mg) in Inventive Example 1 was changed as shown below in [Table 1] with respect to the electrically conductive polyaniline weight (mg).

### Inventive Example 5

An NMP solution in which the reduced-dedoped polyaniline was dissolved was prepared by the same operation as in Inventive Example 1. Subsequently, an NMP solution in which 4.5% by weight of polyacrylic acid (AS58 available from Nippon Shokubai Co., Ltd.) was dissolved was prepared.

Next, 10 g of the NMP solution of polyaniline and 4.4 g of the NMP solution of polyacrylic acid were mixed together. The mixture was subjected to the film formation on the glass plate, the solvent substitution and the drying process by the same operation as in Inventive Example 1.

The resultant film had a thickness of 390 μm and a porosity of 74%. A battery cell was produced in the same manner as in Inventive Example 1.

### Inventive Examples 6 to 8

A cell was produced in substantially the same manner as in Inventive Example 5 except that the electrolyte solution weight (mg) in Inventive Example 5 was changed as shown below in [Table 1] with respect to the electrically conductive polyaniline weight (mg).

### Inventive Example 9

At a room temperature, 20 g of the reduced-dedoped polyaniline powder produced in the same manner as in Inventive Example 1 was stirred to dissolve in 80 g of an NMP solution. The resulting solution was suction-filtered, so that insoluble matter was removed and the solution was defoamed. Thus, a polyaniline solution was provided.

Subsequently, an NMP solution in which 4.5% by weight of polyacrylic acid (AS58 available from Nippon Shokubai Co., Ltd.) was dissolved was prepared in the same manner as in Inventive Example 5.

Next, 10 g of the NMP solution of polyaniline, 17.7 g of the NMP solution of polyacrylic acid and 0.28 g of acetylene black (the trade name of DENKA BLACK available from Denki Kagaku Kogyo Kabushiki Kaisha) serving as the conductive agent were stirred and mixed together at a room temperature. Thereafter, the mixture was defoamed under a reduced pressure. Thereafter, the defoamed mixture was subjected to the film formation on the glass plate, the solvent substitution and the drying process by the same operation as in Inventive Example 1.

The resultant film had a thickness of 76 μm and a porosity of 68%.

### Inventive Examples 10 to 12

A cell was produced in substantially the same manner as in Inventive Example 9 except that the electrolyte solution weight (mg) in Inventive Example 9 was changed as shown below in [Table 1] with respect to the electrically conductive polyaniline weight (mg).

### Comparative Example 1

A porous film was produced in substantially the same manner as in Inventive Example 1, except that the brown dedoped polyaniline powder prepared prior to Inventive Example 1 was used in place of the reduced-dedoped polyaniline powder in Inventive Example 1. The resultant film had a thickness of 210 μm and a porosity of 85%.

### Comparative Examples 2 to 4

A cell was produced in substantially the same manner as in Comparative Example 1 except that the electrolyte solution weight (mg) in Comparative Example 1 was changed as shown below in [Table 1] with respect to the electrically conductive polyaniline weight (mg).

### Comparative Example 5

An attempt was made to produce a porous film in substantially the same manner as in Inventive Example 5, except that the brown dedoped polyaniline powder prepared prior to Inventive Example 1 was used in place of the reduced-dedoped polyaniline powder in Inventive Example 5. However, when the solution mixture of the polyaniline solution and the polyacrylic acid solution was prepared, a precipitate was formed. As a result, the production of a porous film failed.

<Evaluations of Cells>

Assuming that the tentative weight capacity density of polyaniline was 147 mAh/g, a full capacity (mAh) was calculated from the amount of polyaniline contained per electrode unit area, and the rate at which this capacity was charged for 1 hour was defined as 1C charge.

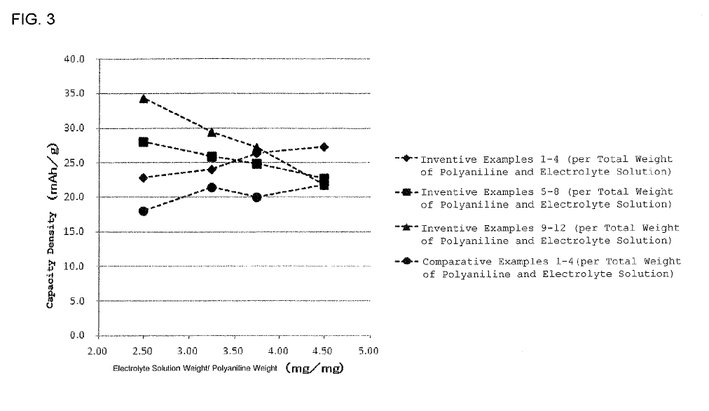

The battery was charged to 3.8 V at a 0.05C-equivalent current value. After 3.8 V was reached, the charge process was changed to a constant-potential charge process. After the charging, the battery was allowed to stand for 30 minutes. Thereafter, the battery was discharged at a 0.05C-equivalent current value until the voltage reached 2 V. This discharge capacity was measured, and the capacity density (mAh/g) per electrically conductive polyaniline weight (mg) was calculated. Also, the capacity density (mAh/g) per total weight of the electrically conductive polyaniline and the electrolyte solution was calculated. The results of the characteristics of the battery employing this electrode are shown below in Table 1 and in FIGS. 2 and 3.

TABLE 1

| | | | | | | Capacity density |
|---|---|---|---|---|---|---|
| | | | | | Capacity | per total weight |
| | | | | Electrolytic | density per | of polyaniline |
| | Oxidized | | | solution/ | polyaniline | and electrolytic |
| | state of | Polyacrylic | Acetylene | polyaniline | weight | solution |
| | polyaniline | acid | black | (mg/mg) | (mAh/g) | (mAh/g) |
| Inv. Ex. 1 | Reduced state | No | No | 4.5 | 150 | 27.3 |
| Inv. Ex. 2 | Reduced state | No | No | 3.5 | 125 | 27.8 |
| Inv. Ex. 3 | Reduced state | No | No | 2.5 | 102 | 25.5 |
| Inv. Ex. 4 | Reduced state | No | No | 1.5 | 80 | 22.9 |
| Inv. Ex. 5 | Reduced state | Yes | No | 4.5 | 125 | 22.7 |
| Inv. Ex. 6 | Reduced state | Yes | No | 3.5 | 118 | 26.2 |
| Inv. Ex. 7 | Reduced state | Yes | No | 2.5 | 110 | 27.5 |
| Inv. Ex. 8 | Reduced state | Yes | No | 1.5 | 98 | 28 |
| Inv. Ex. 9 | Reduced state | Yes | Yes | 4.5 | 130 | 21.8 |
| Inv. Ex. 10 | Reduced state | Yes | Yes | 3.5 | 129 | 28.7 |
| Inv. Ex. 11 | Reduced state | Yes | Yes | 2.5 | 125 | 31.3 |
| Inv. Ex. 12 | Reduced state | Yes | Yes | 1.5 | 120 | 34.3 |
| Comp. Ex. 1 | Oxidized state | No | No | 4.5 | 120 | 21.8 |
| Comp. Ex. 2 | Oxidized state | No | No | 3.5 | 90 | 20 |
| Comp. Ex. 3 | Oxidized state | No | No | 2.5 | 75 | 21.4 |
| Comp. Ex. 4 | Oxidized state | No | No | 1.5 | 45 | 18 |
| Comp. Ex. 5 | Oxidized state | Yes | No | 4.5 | *— | *— |

*Comparative Example 5 has no capacity density data because no porous film was prepared.

The results of Table 1 and FIGS. 2 and 3 showed that the values of the capacity density (mAh/g) per total weight of the polyaniline and the electrolyte solution in Inventive Examples 1 to 4 were greater than those in Comparative Examples 1 to 4. From this, it is found that the use of the electrode formed from the polyaniline solution in the reduced state improves the doping ratio of the active material to provide an excellent electricity storage device, as compared with the polyaniline powder in the oxidized state.

It was found from Table 1 and FIG. 3 that, when the electrolyte solution weight was decreased, the capacity density per total weight of the polyaniline and the electrolyte solution in Inventive Examples 5 to 8 in which the polyacrylic acid was added to the polyaniline solution in the reduced state did not decrease but increased, as compared with Inventive Examples 1 to 4 in which the polyacrylic acid was not added.

Further, it was found from Table 1 and FIG. 3 that, when the electrolyte solution weight was decreased, the capacity density per total weight of the polyaniline and the electrolyte solution in Inventive Examples 9 to 12 in which the polyacrylic acid and the conductive agent were added to the polyaniline solution in the reduced state did not decrease but had a strong tendency to increase, as compared with Inventive Examples 1 to 4 and Inventive Examples 5 to 8.

From the above description, the use of the electrode made from the solution having the electrically conductive polymer (A) in the reduced state and the further addition of the polycarboxylic acid (B) and the conductive agent (C) to the solution not only increase the capacity density but also increases the capacity density per polyaniline weight even if the electrolyte solution weight is decreased. This achieves the prevention of degradation due to the exhaustion of the electrolyte solution, and the size reduction of the electricity storage device.

While specific forms of the embodiment of the present invention have been shown in the aforementioned inventive examples, the inventive examples are merely illustrative of the invention but not limitative of the invention. It is contemplated that various modifications apparent to those skilled in the art could be made within the scope of the invention.

The electricity storage device according to the present invention is advantageously used as an electricity storage device such as a lithium secondary battery. The electricity storage device according to the present invention can be used for the same applications as the prior art secondary batteries, for example, for mobile electronic apparatuses such as mobile PCs, mobile phones and personal data assistants (PDAs), and for driving power sources for hybrid electric cars, electric cars and fuel battery cars.

### REFERENCE SIGNS LIST

1 Current collector (for positive electrode)
2 Positive electrode
3 Electrolyte layer
4 Negative electrode
5 Current collector (for negative electrode)

1. An electricity storage device comprising an electrolyte layer, a positive electrode, and a negative electrode, wherein the electrolyte layer is interposed between the positive and negative electrodes, wherein at least one of the electrodes is a porous film made from a solution having an electrically conductive polymer (A) in a reduced state.

2. The electricity storage device according to claim 1, wherein the solution having the electrically conductive polymer (A) in the reduced state further contains a polycarboxylic acid (B).

3. The electricity storage device according to claim 1, wherein the solution having the electrically conductive polymer (A) in the reduced state further contains a conductive agent (C).

4. An electrode for an electricity storage device, the electrode being a porous film made from a solution having an electrically conductive polymer (A) in a reduced state.

5. The electrode for an electricity storage device according to claim 4, wherein the solution having the electrically conductive polymer (A) in the reduced state further contains a polycarboxylic acid (B).

6. The electrode for an electricity storage device according to claim 4, wherein the solution having the electrically conductive polymer (A) in the reduced state further contains a conductive agent (C).

7. A porous sheet for an electricity storage device electrode, the porous sheet being a porous film made from a solution having an electrically conductive polymer (A) in a reduced state.

8. The porous sheet for an electricity storage device electrode according to claim 7, wherein the solution having the electrically conductive polymer (A) in the reduced state further contains a polycarboxylic acid (B).

9. The porous sheet for an electricity storage device electrode according to claim 7, wherein the solution having the electrically conductive polymer (A) in the reduced state further contains a conductive agent (C).
